(19) United States
(12) Patent Application Publication
(10) Pub. No.: US 2022/0253775 A1
(43) Pub. Date: Aug. 11, 2022

(54) Automated Lead Generation

(71) Applicant: MS TECH IP LLC, Dover, DE (US)

(72) Inventors: Alex Burkhead, Mount Vernon, NY (US); Gregory J. Mouracade, Mount Vernon, NY (US)

(21) Appl. No.: 17/520,286

(22) Filed: Nov. 5, 2021

Related U.S. Application Data
(60) Provisional application No. 63/109,918, filed on Nov. 5, 2020.

(51) Int. Cl. G06Q 10/06; G06Q 30/02; G06F 16/2457

(52) U.S. Cl. CPC G06Q 10/06315; G06Q 30/0202; G06F 16/24578; G06Q 30/0201

(57) ABSTRACT

A evaluation server 102 configured for accessing and storing information in a standardized format about the status of a listing in a plurality of network-based non-transitory storage devices having a collection of listings; providing remote access to users over a network so users can update the information about the status of a listing through a graphical user interface, wherein the one of the users provides the updated information in a non-standardized format dependent on the hardware and software platform used by the one of the users; converting the non-standardized updated information into the standardized format, storing the standardized updated information about the listing status in the collection listings in the standardized format; automatically generating a message containing the updated information about the listing status whenever updated information has been stored; and transmitting the message to at least a portion of the users over the computer network in real time.

### CROSS REFERENCE TO RELATED APPLICATION

The present application claims the benefit of U.S. patent application Ser. No. 63/109,918, filed Nov. 5, 2020, which is hereby incorporated by reference in its entirety.

### FIELD OF INVENTION

The present invention relates generally to the field of automating database queries and generating custom output files associated with lead generation and potential customer identification within the real estate market.

### BACKGROUND OF THE INVENTION

It is often desirous to optimize lead generation in various industries that rely on customers. For example, various service providers, such as movers, rental companies, craftspeople and others often contract with new homeowners in need of their services. However, identifying those homeowners that are most likely to need the services of a particular vendor can be a vexing problem. One solution is to continuously monitor real estate transactions in a given area and simply offer services to each potential customer. Such approaches, however, are inefficient, time consuming and costly. Furthermore, the systems available for such monitoring are typically fragmented by market, technology type or other restrictions of interoperability. Thus, what is needed are systems, methods and computer implemented products that aids a user in accessing data from multiple data sources and allow the user to dynamically monitor real estate transactions and determine. Furthermore, what is needed is a system and computer implemented method that aids a user in identifying potential contact targets or communication recipients based on various data points identified through multiple database queries.

### SUMMARY OF THE INVENTION

A system for automated lead generation is provided. In one implementation, a database of transactional data is accessed. For instance, a database of property or real estate sale listing are accessed by one or more processors of a lead generation system. In a particular configuration, a user interface is presented to a user. The user interface allows the user to access the database of transactional data (i.e. real estate listings) and generate one or more subcategories of data based on a pre-determined dataset criterion. The user is able to generate one or more sub-categories of data from the database that correspond to a custom transactional market based on pre-selected criteria, such as a geographic area, property type, or purchase price.

Using the generated subcategory of data, the user is able to generate one or more direct communications with one or more entities associated with the transaction entry. For instance, the user is presented with one or more user interface elements, that when selected, cause the generation of a message that is addressed to the property owner or realtor associated with the transaction entry. Once these messages have been sent to the recipient of the message, the message itself and/or the transaction associated with the message can be tracked over time. In the event that an inquiry from a property owner or realtor is received, the inquiry is, in one arrangement, automatically parsed using a natural language processing agent or model, that associates the inquiry with the originating communication and follow-up communications can be initiated. In one or more further implementations, a pre-set response is generated based on a communications model that evaluates prior successful communications and generates a proposed follow-up communication based on prior successful communications.

In an alternative configuration, a lead generation system is provided where the system includes a processor configured by code executing therein to access a dataset from one or more property listing databases. The processor is further configured to classify, according to one or more classification criteria, one or more sub categories of the dataset and to rank each entry within the one or more subcategories based on one or more ranking criteria. The processor is further configured to generate at least one message to each entry in the one or more sub category that is ranked above a pre-determined threshold. In a particular implementation, the generated message includes one or more offers for a service. In a further step, the processor is configured to store, in at least one remote database a copy of the generated message and send, to at least one recipient, the at least one generated message. After the message has been sent, the processor is configured to receive, from one or more remote users, one or more service inquiries. These received inquiries are matched to the one or more stored generated messages. The processor is further configured to update the rank of each entry based the received service inquiry.

### BRIEF DESCRIPTION OF THE DRAWINGS

The present invention may be best understood by reference to the following drawings which are meant to be exemplary and not limiting, in which like references are intended to refer to like or corresponding parts and which:

FIG. 1 provides a system configuration to carry out the processes and methods described herein.

FIG. 2 provides a flow diagram of a particular implementation of the lead generation system described.

FIG. 3A provides a block diagram of particular elements of the lead generation system described.

FIG. 3B provides a block diagram of particular elements of the lead generation system described.

FIG. 4 provides a flow diagram of a particular implementation of the lead generation system described.

FIG. 5 shows an example of a display screen that is provided in connection with processes associated with the lead generation system described.

FIG. 6 shows an example of a display screen that is provided in connection with processes associated with the lead generation system described.

FIG. 7 shows an example of a display screen that is provided in connection with processes associated with the lead generation system described.

FIG. 8 shows an example of a display screen that is provided in connection with processes associated with the lead generation system described.

FIG. 9 shows an example of a display screen that is provided in connection with processes associated with the lead generation system described.

FIG. 10 shows a block diagram provided in connection with processes associated with the lead generation system described.

FIG. 11 shows an example of a flow diagram detailing processes associated with the lead generation system described.

### DETAILED DESCRIPTION

In one or more implementations, the systems, methods and computer implemented approaches provided herein include accessing one or more remote or local data stores and extracting transaction records. For example, the system described herein is configured to evaluate open transactions. Open transactions, as used herein, refer to real estate listings that have yet to be completed (i.e. properties that are for sale but have not yet been sold). Using this data, one or more processors of the system described can provide a dynamic user interface that allows users to categorize, filter and update market participants involved in such real-estate transactions.

It will be appreciated that present systems present difficulties in obtaining and utilizing information stored within and across multiple transaction databases. Transaction databases tend to be in proprietary formats that do not allow easy searching using a single query or resource request. Such drawbacks exist uniquely in computer networks and different providers seek to ensure that customers use a preferred format for queries or obtaining resources. By way of broad overview and introduction, the systems, methods and computer implemented approaches described herein are directed to solving these technical computer issues that arise in the context of networked transaction databases.

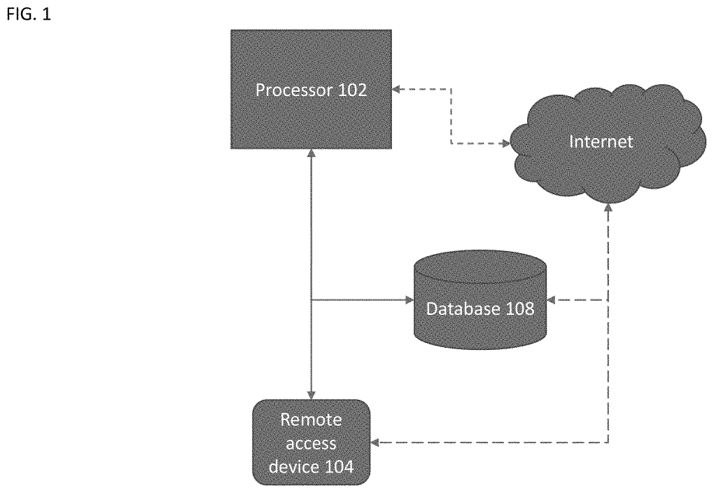

Referring now to the drawings, in which like reference numerals refer to like elements, FIG. 1 illustrates a market transaction evaluation, inference and assessment system. Here, one or more computers are configured to execute code (e.g. an evaluation server 102). In a particular implementation, the evaluation server 102 includes one or more suitably configured processors having a memory and configured to execute code stored therein. The evaluation server 102 is configured to access, from one or more local or remote data storage repositories, a collection of stored information material or content. For example, as discussed herein, the evaluation server 102 is configured to access real estate market data and make determinations as to particular transactions or participants that have a need, or likely need, for particular services.

The evaluation server 102 is configured to access information material and content from one or more databases, such as database 108. In another implementation, the evaluation server 102 is configured to access data from one or more databases or other remote data storage devices, such as cloud servers, or cloud storage devices. For instance, database 108 is a database or data store of real estate transaction data, county records, deeds, tax or other commercial or custom information. In one or more implementations, the database 108 can be accessed by way of direct connection, user interface, website, programmatic API (Application programming interface) or other mechanism for accessing one or more remote data storage devices or services. In a further implementation, multiple data sources are available to the evaluation server 102 such that a plurality of different transaction databases can be accessed simultaneously or concurrently.

The evaluation server 102 accesses content through a local area network, intranet, or internet. Such data exchanges can include one or more network interfaces, gateways, firewalls, security servers or other network hardware that permits or enables bidirectional data exchanges between the evaluation server 102 and databases 108.

The evaluation server 102 is further configured to generate, upon evaluation of the accessed content, output datasets that are stored to local or remote data stores, such as database 108. Additionally, the evaluation server 102 is configured to transmit or send the generated output datasets to one or more remote accesses devices 104, such as computers or other data processing platforms.

The users of the remote access devices 104 are also able to access though the evaluation server 102, the content of the database(s) 108 and other data associated with the output dataset or general data accessible or utilized by the evaluation server 102.

As used herein, “processor” or “computer” refers one or more electronic devices (e.g. semiconductor-based microcontrollers) configured with code in the form of software, to execute a given instruction set. For example, the evaluation server 102, database(s) 108 and remote access devices 104, include one or more processing or computing elements executing commercially available or custom operating system, e.g., MICROSOFT WINDOWS, APPLE OSX, UNIX or Linux based operating system implementations. In other implementations, evaluation server 102, database(s) 108 and remote access devices 104 each include custom or non-standard hardware, firmware or software configurations. For instance, the processor or computer can include one or more of a collection of micro-computing elements, computer-on-chip, field programmable gate arrays, graphical processing units, home entertainment consoles, media players, set-top boxes, prototyping devices or “hobby” computing elements. Such computing elements described are connected, directly or indirectly, to one or more memory storage devices (memories) to form a microcontroller structure. The memory is a persistent or non-persistent storage device that is operative to store an operating system for the processor in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules.

The computer memories may also comprise secondary computer memory, such as magnetic or optical disk drives or flash memory, that provide long term storage of data in a manner similar to the persistent memory device. In one or more embodiments, the memory of the processors (such as a processor of the evaluation server 102) provides for storage of application programs and data files when needed.

The processors or computers described are configured to execute code written in a standard, custom, proprietary or modified programming language such as a standard set, subset, superset or extended set of JavaScript, PHP, Ruby, Scala, Erlang, C, C++, Objective C, Swift, C#, Java, Assembly, Go, Python, Perl, R, Visual Basic, Lisp, TensorFlow for ML, mClust, or Julia or any other object oriented, functional or other paradigm based programming language.

In one particular implementation, the evaluation server 102 is a server, computing cluster, cloud platform or computing array, configured to directly, or through a communication linkage, communicate and exchange data with the one or more remote access devices 104 and/or databases 108.

As provided in the illustrated implementation, the evaluation server 102 is a computer server configured by code executing therein to accept electronic data queried from one of more remote data storage locations (e.g. database 108) and evaluate the queried or accessed data according to pre-determined or dynamic rules, logic, instructions or algorithms.

In a particular implementation, the evaluation server 102 is configured with one or more remote or local data storage devices that store operating code, as well as user information. The evaluation server 102 is also configured to access remote resources such as third-party vendor information, user data, and communication data from third parties through implementation of code modules.

As the implementation of FIG. 1 illustrates, the evaluation server 102 is used to evaluate the content of the database(s) and, based on evaluation of the content, generate new content or reference to particular content. For example, the content stored in the databases are transformed into visualizations suitable for a lay user to assess or comprehend the interactions between and among the data.

With particular reference to FIG. 1, the content database 108 is one or more datastores in communication with at least one processor of the evaluation server 102. The physical structure of the database(s) 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. The database 108 includes the necessary hardware and software to enable a processor local to the evaluation server 102 to retrieve and store data within the database 108.

With more particular reference to FIG. 1, the remote access devices 104 are used to exchange data, such as electronic messages, data packages, streams or files, over a network to the evaluation server 102. In one implementation, the remote access device(s) 104 connects to the evaluation server 102 directly, such through an internal local network. Alternatively, remote access devices 104 connect to the evaluation server by first connecting to the Internet (as shown in dashed lines).

As used herein, the remote access device 104 is a general or single purpose computing device configured by hardware or software modules to connect to a network and receive data from the evaluation server 102. For example, the remote access device 104 is a personal communication device (smartphone, tablet computer, etc.), configured by one or more code modules to exchange data with the evaluation server 102. Remote access device 104 utilizes wired or wireless communication means, such as, but not limited to CDMA, GSM, Ethernet, Wi-Fi, Bluetooth, USB, serial communication protocols and hardware to connect to one or more access points, exchanges, network nodes or network routers.

In one implementation, remote access devices 104 are portable computing devices such as Apple iPad/iPhones®, Android® devices or other electronic devices executing a commercially available or custom operating system, e.g., MICROSOFT WINDOWS, APPLE OSX, UNIX or Linux based operating system implementations. In other implementations, remote access devices 104 are, or include, custom or non-standard hardware, firmware or software configurations. Here, the remote access devices 104 can communicate with the one or more remote networks using USB, digital input/output pins, eSATA, parallel ports, serial ports, FIREWIRE, Wi-Fi, Bluetooth, or other communication interfaces. In one or more configurations, the remote access devices 104 are also configured, through hardware and software modules, to connect to more remote servers, computers, peripherals or other hardware using standard or custom communication protocols and settings (e.g., TCP/IP, etc.) either through a local or remote network or through the Internet.

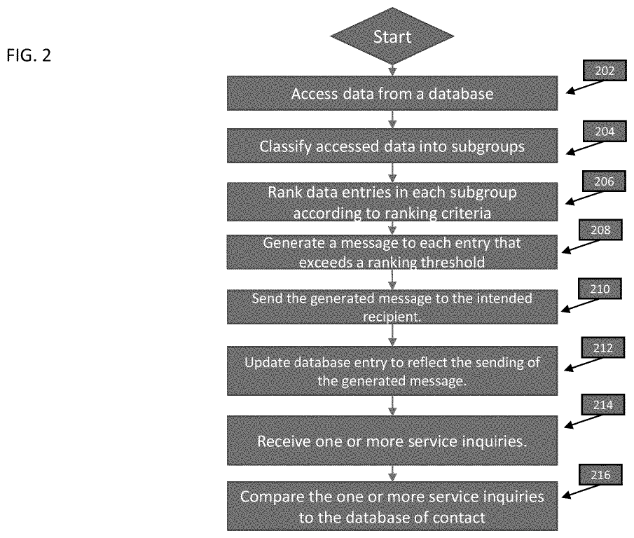

As shown in FIG. 2, a flow diagram is provided detailing one or more steps carried out by a suitably configured processor of the evaluation server 102. In one or more configurations, each of the detailed steps recited is implemented or carried out by one or more modules or submodules of code executing in one or more processors of the evaluation server 102.

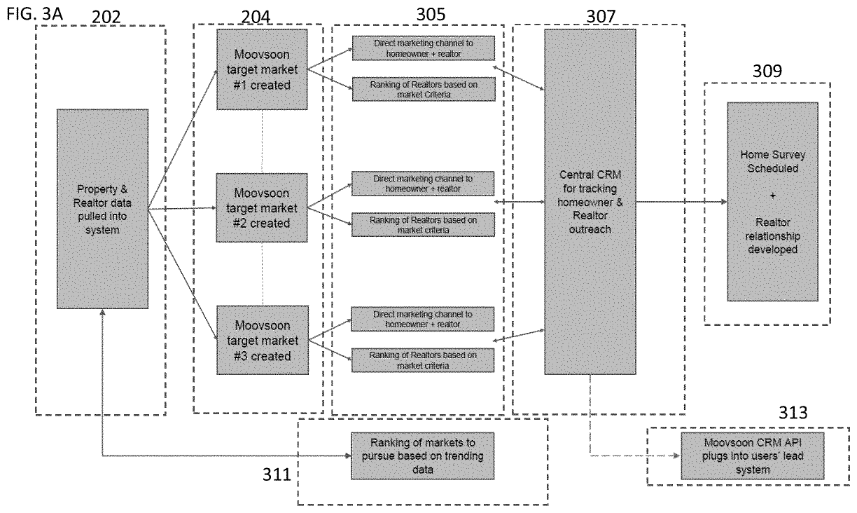

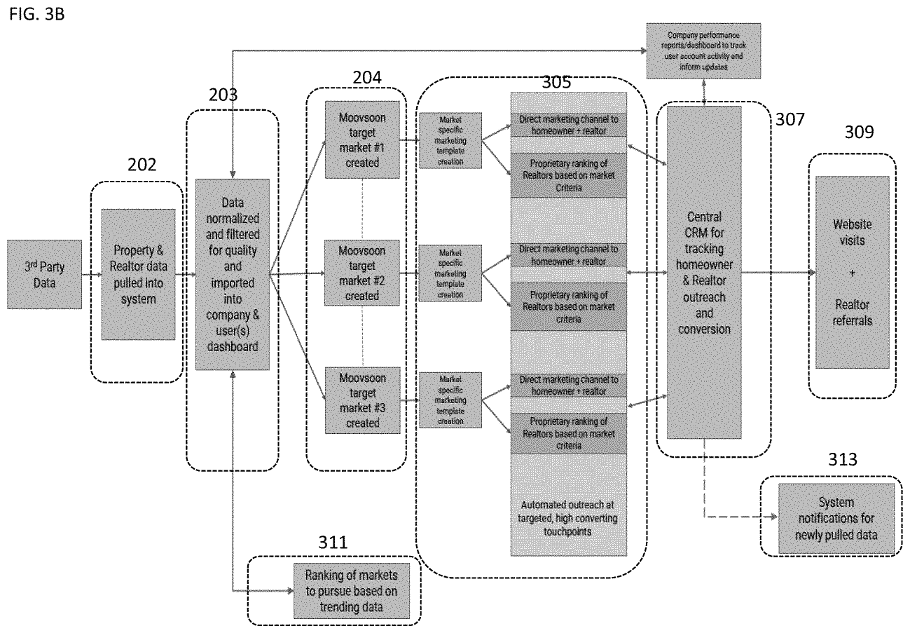

By way of particular example, upon initiation of a start signal or flag, the evaluation server 102 is configured by one or more modules to carry out an instruction set stored in a memory thereof. For example, the evaluation server 102 is configured by an access module, configured as code, to access data from one or more remote databases, such as a collection of real estate listings. As shown in step 202 of FIGS. 2 and 3, the access module configures a processor of the evaluation server 102 to access one or more databases (such as but not limited to database 108) containing relevant information. In one arrangement the access module configures a processor of the evaluation server 102 to access databases using one or more query languages or protocols that allow for searching or accessing specific portions of the database.

In one or more particular implementations, the evaluation server 102 is configured by one or more conversion or normalization modules. For example, and as shown in FIG. 3B, when the evaluation server 102 accesses one or more APIs (such as one or more real estate listing APIs), the data accessed is processed, normalized or converted into a standardized format. By way of non-limiting example, the data returned from the API is evaluated by the evaluation server 102 for errors or missing data field. For instance, the evaluation server 102 is configured by the conversion modules to identify the name or identity field of the returned data. Where the data values corresponding to the name are not in a standardized format (such as first and last name), the conversion module configures the evaluation server 102 to replace the data values with the corrected data values. For instance, where the name value is a text string that includes a comma or semicolon, the conversion module configures the evaluation server 102 to separate the string into two strings representing the first and last name of the data subject. Alternatively, where the data values are not text strings (for example a number is returned in place of a text string), the conversion module configures the evaluation server 102 to replace the data with a pre-set string value. For example, where the evaluation server 102 is configured by the evaluation module to identify likely errors in the data returned, the evaluation server 102 is configured to recognize these errors in the data and tag the data with a new label, such as “resident.” In this way, the evaluation server 102 is configured to standardize the owners' names into first and last and exclude any errors within the data returned by the data sources. In one or more implementations, a trained neural network or natural language processing model or agent is used to identify errors within the returned dataset and automatically correct the flagged errors.

In another configuration, the evaluation server 102 is configured to compare two different data sets to correct for flagged errors. For example, where the data returned from one API for a given listing includes an error, a different API can be queried to supplement or correct the error. For example, where a real estate listing data base includes a first collection of data, a second real estate listing database can be queried to determine additional data about the same listing. In an alternative configuration, a second data set can be used to filter the first dataset. For example, where a first dataset is filtered on the basis of a given criteria (such as sales price) a second database can be used to filter the results (such as by the flag “owner occupied.”). This data set can then be used to filter down data shown to users.

In yet a further implementation, the evaluation server 102 is configured to compare two different data sets to correct for flagged errors. For example, where evaluation server is configured to execute a similar query on two different databases or dataset. Here the query could be a request for all transactions occurring within a given time period. The evaluation server is configured to evaluate the data returned from the simultaneous queries and compare the entries. For example, each transaction entry originating from a first database query is matched to returned database entries from the second database entry. Where the an entry from the first and second databases have substantial similarity (such but not limited to as determined based on Ngram frequency or other Natural language processing techniques) they are treated as a single transaction. Unmatched transactions are then flagged with one or more visual indicators to indicate that these transactions either contain errors or are missing from one of the comparison databases.

Turning now to step 204, a processor of the evaluation server 102, in one or more implementations, is configured by a classifier module. In one arrangement, the classifier module configures a processor of the evaluation server 102 to group, aggregate or classify the data accessed into one or more groups. For instance, where data for a geographic region is accessed, the classification step 204 involves automatically grouping open transactions by zip code, school district, address, price, duration or another classification category.

In one arrangement, as shown in FIG. 3, a processor of the evaluation server 102 is configured in step 204 to group or classify the data accessed in step 202 into multiple groups depending on some specific classification criteria. For instance, where classifier module causes the processor of the evaluation server 102 to classify the accessed data, the processor can store the sub-groups of data in one or more accessible memories. Alternatively, a processor of the evaluation server 102 is configured by the classifier module to tag, flag or index each transaction with one or more classification markers. In this arrangement, the data is not segregated into groups, but instead is labeled for further processing.

As shown in step 206 of FIG. 2, the processor of an evaluation server 102 is configured by more ranking modules. Here the ranking modules evaluate the listings according to one or more criteria. In one instance, the ranking criteria is a single or combined metric, such as price, property size, prior history, time on market, or date of posting of a given listing. The evaluation server 102, in one implementation, is configured to rank or list the transactions in a given category based on these metrics.

In an alternative configuration, the ranking modules configures one or more processors of the evaluation server 102 to rank the entries in a subgroup according to one or more ranking algorithms. By way of example, a processor of the evaluation server 102 is configured to access, using one or more submodules of the ranking module, a ranking algorithm or ranking model. A dataset can be accessed by a processor of the evaluation server that includes various data features associated with a real estate transactions, such as price, date, location, dwelling details (i.e. number of rooms), square footage, owner name, realtor name, purchaser name, purchaser agent etc. The accessed data can also include information indicating whether certain services were used in connection with the given transaction, such as the hiring of a moving company or relocation service.

In one arrangement, a processor of the evaluation server 102 is configured by one or more ranking modules to rank the entries in the one or more categories using a derived or accessed evaluative model. For instance, as shown in step 206, each listing is evaluated according to the evaluation model and the listings are ranked according to how likely a given listing will result in additional purchase of services.

In step 208, a processor of the evaluation server 102 is configured to access, for each ranked transaction, contact data. For example, where the listing data that is accessed, classified and ranked by a processor of the evaluation server 102 further includes one or more e-mail address, telephone numbers, or physical mailing addresses, a processor of the evaluation server 102 server is configured to access this contact data. In one arrangement the accessed contact information for a given listing is used by a processor of the evaluation server 102 to generate a message to an intended recipient that is associated with the evaluated listing.

By way of non-limiting example, a processor of the evaluation server 102 is configured by a messaging module to access e-mail addresses for each realtor involved with a pending, or recently concluded listing. In an alternative arrangement, a processor of the evaluation server 102 is configured to access the mailing address for the property described in the open listing. In a further arrangement, a processor of the evaluation server 102 is configured to cross-reference particular data from the transaction with third-party records, such as tax, mailing and other database to identify the owner of a property. Using this information, the processor of the evaluation server 102 generates a custom message that provides pertinent details regarding a particular good or service. In one arrangement, where the transactions have been ranked based on the likelihood that a user will purchase services, the generated message will include reference to the particular good and services offered.

As noted, the evaluation server 102 is configured to generate a message to an intended recipient associated with a flagged or filtered listing. In a further implementation, the evaluation server 102 is configured to integrate with the messaging systems of the users. By way of non-limiting example, where the user has sent out a message to the owner of, or realtor associated with, a flagged or filtered listing, the evaluation server 102 is configured to evaluate the messaging system to automatically flag any replies. For instance, the evaluation server 102 is configured to evaluate the subject line of an email and compare that data to the listings filtered by the user or messages sent by the user.

As shown in step 210, the generated messages are then sent to the recipients. For example, a processor of the evaluation server 102 is configured to access one or more remote printing and mailing facilities that is configured to receive a data set of intended recipients, the corresponding messages, and the message type. In one instance, those listings that are determined to have the highest likelihood resulting in a customer purchasing a good or service are evaluated for an electronic or physical mailing address for an individual associated with the listing. Likewise, those listings that are ranked below a pre-determined threshold, are evaluated for only an electronic mailing address. In this way, the described approach is able to optimize and conserve physical resources associated with direct mailing campaigns. Furthermore, such an approach allows the system described to direct such resources to targeted customers. Here, the less likely candidates will still receive a contact and offer for services, but such an offer will be provided through a more economical e-mail message.

Where the message is a physical mailing (such as, but not limited to a post card), the evaluation server 102 is configured to transmit both the message contents, the intended recipient and any other content to be printed on the physical medium (e.g. graphics, images, logos etc.) to a remote printing server. Here the remote printing server is configured to receive the data, and generate, using one or more printing devices, the relevant messages. These generated messages are then assigned the requisite postage and sent to the intended recipients. In one or more implementations, the printing server and associated physical printers and postage system are configured as a fully automated system that is able to print and affix postage to physical media.

Upon sending the messages electronically or physically, the evaluation server 102 is configured to update the data set of transition entries with an additional flag or label indicating that a message has been sent to at least one individual associated with this transaction (i.e. the relator or home owner). For example, as shown in step 212, one or more processors of the evaluation server 102 is configured to access each record of an open transaction and assign at least one data value or flag to the transaction that indicates that a message was sent.

As shown in step 214, a processor of the evaluation server 102 is configured to access or receive data from one or more CRM (Customer Relationship Management) systems. Such CRM systems are utilized to track and manage customer relationships. In one or more implementations, the evaluation server 102 is configured to access or communicate with a CRM system to monitor incoming customer requests for services. For instance, where the CRM system logs a request for service (i.e. moving or relocation services), this log is transmitted to the evaluation server 102. Configured by a customer module, a processor of the evaluation server 102 accesses the service request and parses the service request for relevant data. The name, address and contact information of the actual or potential customer request information about services is then extracted from the request log. For example, where the request log indicates that a customer is requesting services, a processor of the evaluation server 102 is configured to identify the transaction record (i.e. real estate listing) that corresponds to the customer. Here, the real estate listing might correlate to a particular property being sold by the customer or being purchased by the customer. Thus, the customer request combined with the real estate listing can be evaluated for relevant factors that led to the services being requested.

In another implementation, as shown in step 216, the request log, or the data included therein, is compared to the entries in the dataset accessed in step 202. An update module configures a processor of the evaluation server 102 to update the dataset to indicate whether a request log has been received from any of the recipients that was sent a message in step 210.

In a further implementation, the evaluation server 102 is configured with a reporting module. Here, the reporting module configures the evaluation server 102 to aggregate all the data from a user's profile and presents it via comma-separated value (CSV)/email format to the user. The reporting module further configures the evaluation server 102 to filter or narrow down specific criteria of listing or realtor of interest to the user. In one or more implementations, the evaluation server 102 is further configured to take CRM data and combine such data with the aggregate data. Such combined data can then be presented to the user as part of a sales/opportunity pipeline.

In a further particular implementation, the system described in FIG. 2, can be implemented as a method to allow users to update in real time the status of listings and/or sales relating to those listing so as to optimize the opportunity pipeline. For example, the evaluation server 102 is configured for a) accessing and storing information in a standardized format about the status of a listing in a plurality of network-based non-transitory storage devices having a collection of listing thereon b) providing remote access to users over a network so any one of the users can update the information about the status of a listing in the collection of listings in real time through a graphical user interface, wherein the one of the users provides the updated information in a non-standardized format dependent on the hardware and software platform used by the one of the users; c) converting, by an evaluation server, the non-standardized updated information into the standardized format, d) storing the standardized updated information about the listing status in the collection listings in the standardized format; e) automatically generating a message containing the updated information about the listing status by the evaluation server whenever updated information has been stored; and f) transmitting the message to at least a portion of the users over the computer network in real time, so that the at least a portion of the user has immediate access to up-to-date listing information.

Turning now to the flow diagram of FIGS. 3A and 3B, a processor of the evaluation server 102 is as shown in step 305, which can take place after step 202, or any subsequent step. As shown, a processor of the evaluation server 102 is configured by a realtor ranking module. The realtor ranking module configures one or more processors of the evaluation server 102 to evaluate one or more service providers, such as realtors. Here, the realtors are ranked according to one or more ranking algorithms. For example, such ranking can take into account the number of listings that reference a particular realtor or the realtor organization, the average selling or purchase price for each transaction associated with a particular realtor, or additional or other factors related thereto.

As shown in FIGS. 3A and 3B, the ranking of realtors can be used to identify one or more realtors to receive communications from the evaluation server 102. As such, the process outlined in steps 206-208 are undertaken to generate and send messages to one or more relators that have an assigned rank above a dynamically generated or pre-determined threshold value.

As shown in step 307, the ranked realtor and/or listings are tracked in the customer relationship system so that realtors and buyers/sellers can be contacted, and such contact can be followed upon with subsequent contacts. In one or more arrangements, one or more processors of the evaluation system incorporates CRM systems. Here, the incorporated CRM systems allow for data generated and stored by the evaluation system to be accessible to one or more remote users of the CRM system. For instance, a user of a remote device 104 is able to interface with the CRM portion of the evaluation server 102 as shown with respect to step 313. The monitoring and contact cycle implemented by the CRM system can persist until a particular monitored realtor and or buyer/seller makes a request for the services, or a relationship is developed, as shown in step 309.

As shown in step 311, which can proceed directly from step 202, a processor of the evaluation server 102 is configured by a ranking module to rank the markets, listings or sub-categories of data accessed. Such listings can be grouped based on market criteria, location, or likelihood to request or acquire services. For instance, a processor of the evaluation server 102 is configured by a ranking module to evaluate each of the listing and group the listings based on the ranking criteria. Here, the subcategories of grouped data can represent listings having a high, medium and low probability of resulting in a service request based on the ranking criteria.

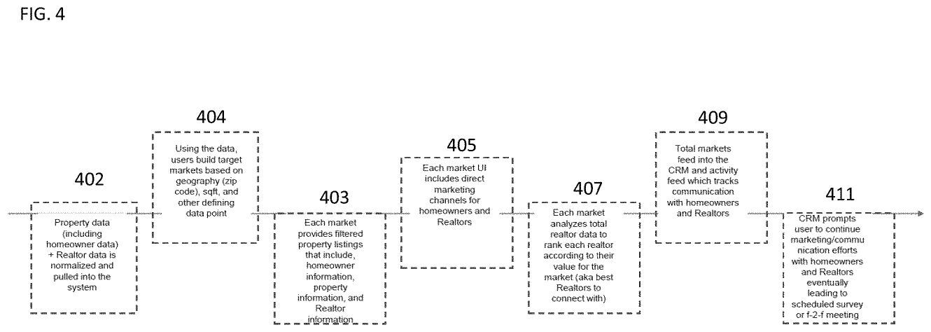

Turning to the flow diagram of FIG. 4, in a particular evaluative process, data is accessed from a source of listings as shown in step 402. Here, such a data acquisition process is similar to the process described in step 202. Likewise, groupings or subcategories of the listing data (i.e. target markets) are generated in step 404, where such a process is similar to the process detailed with respect to step 204. As shown in step 405, the generated and filtered market data is sent to one or more remote devices 104 and displayed on a display device.

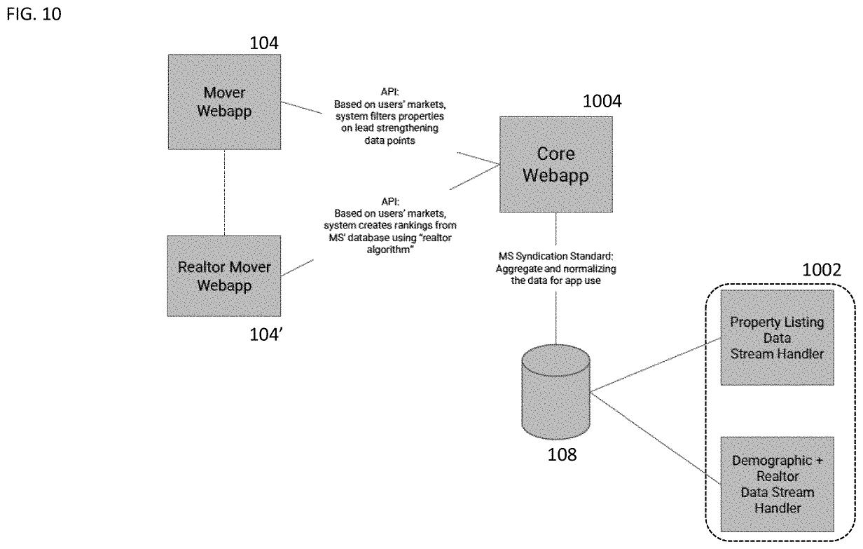

As shown in FIG. 10, the data that is evaluated by the evaluation server 102 is standardized prior to usage. 3rd party data is often provided by various vendors in incompatible forms and formats. Here, the data obtained in step 402 is standardized prior to categorization. Such standardization can include the evaluation processes described in steps 202 of FIGS. 2, 3A and 3B. As shown, the access modules 1002 of the evaluation processor 102 configure it to handle incoming property listing, demographic and realtor data. In one or more implementations, the access modules 1002 are configured to standardize and aggregate the data obtained from 3^{rd} party sources and store that standardized and aggregated data in the database 108. Alternatively, the data can be streamed directly to the evaluation processor configured by one or more evaluative modules 1004.

As shown in step 403, a processor of the evaluation server 102 causes each of the grouped markets to provide filtered property listings that include, in one implementation, home owner information, property information and realtor information. Returning to FIG. 10, the evaluation server is configured to filter the standardized data for presentation to the user. For instance, the evaluation server 1004 (shown configured to provide a CORE webapp) provides to a user interfacing application (Mover webapp) displayed on a remote computing device 104 a filtered dataset. In one or more implementations, the evaluation server 102 is configured to implement a filtering algorithm on the standardized data that filters the data based on a likelihood that the identified transaction is one that will result in the necessity of additional services. For example, the filtering model or algorithm executed by a processor of the evaluation server 102 includes assigning a value to each transaction and then comparing the transaction to a threshold or cutoff value. Where the transaction is above the threshold value, it is provided to the user. In one or more particular implementations, the value assigned to the transaction is derived from a function or model trained on a training data set. By way of non-limiting example only, the described system includes a training module that is configured to train a machine learning or neural network based on classified or tagged data. For example, where the customer outreach (such as provided in steps 307-309) is successful, that data is added to a training database or data set. One or more training modules are configured to use unsupervised or supervised learning algorithms to evaluate the training set and generate a model that accepts new standardized transaction data for evaluation.

In one implementation the dataset is evaluated by a trained model to classify the data to determine the likelihood that the transaction will result in additional services purchased. For instance, the model or algorithm is configured to evaluate whether the transaction is likely to result in the purchase of moving or relocation services based on the pre-coded data about which transactions resulted in the purchase of additional services. Alternatively, the model or algorithm can be trained (including on data generated and validated by the evaluation system itself) to identify or rank vendors. For instance, as shown in FIG. 10, a user can seek a “preferred or top” vendor in a geographic area. In one implementation, a user of a remote access device 104′ seeks the preferred vendor (such as a realtor) in a given geographic location. Here, the transaction data can again be used to derive a trained model that uses one or more data fields of the transaction and correlates those data fields with one or more vendors ranked or classified as high performance.

Once the transactions have been assigned values using the trained model, those transactions meeting the threshold criteria are filtered and provided to a user. In a particular implementation, the data sent by the evaluation server 102 to the remote device 104 causes an application user interface executing on the remote device 104 to generate icons related to direct marketing functionality. For instance, where the data sent to the remote device 104 includes addresses and contact information, the marketing functionality includes one or more software functions that are initiated upon a user selecting a pre-determined or dynamically generated user interface element that corresponds with a function that initiates contact with the homeowner or realtor.

The relators associated with each listing can themselves be ranked as shown in step 407. For instance, the realtors are ranked (as described in FIG. 10) in a process similar to the one outlined in step 305. Thus, the user interface elements generated in step 405 can be utilized to access the contact information of the highest ranked realtors. Alternatively, a list of ranked realtors is provided where each realtor is associated with a rank value and a dynamically generated user interface contact icon. Here, interfacing with the user interface contact icon causes the evaluation server to access the contact information and send a personalized, customized, pre-generated, standardized or other type of communication to the selected realtor.

As shown in step 409, the user interface presented to a user allows for the listing data and CRM tracking data to be viewed remotely by the user. In this way, any user is able to track the realtors or home owners/sellers selected for further contact as shown in step 411.

In one or more implementations, where the tracking and user interaction process results in a purchase of additional services. The transaction originating the purchase of additional services, and its associated data, is copied to the training database for further, and iterative, training of the neural network or machine learning module.

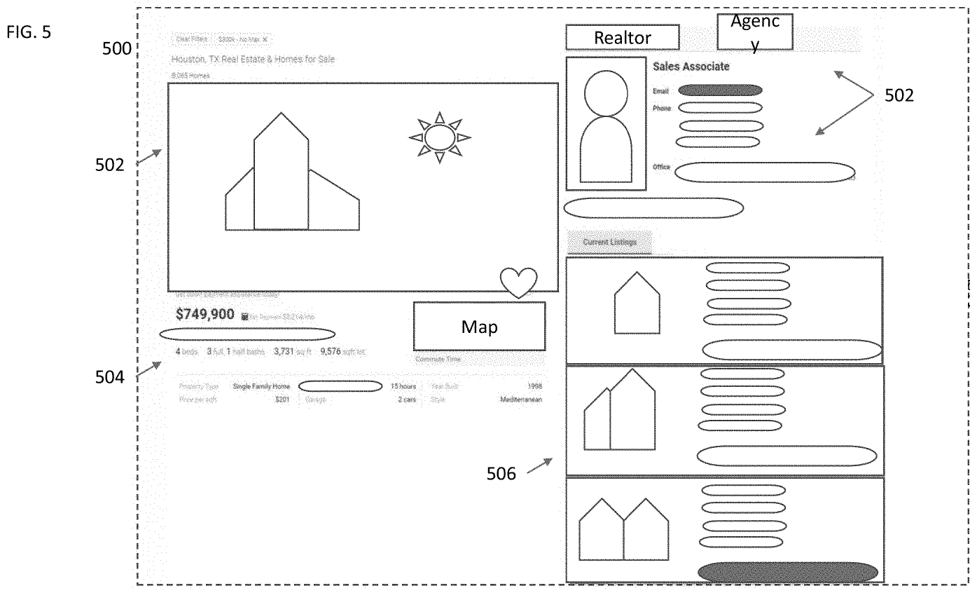

FIG. 5 provides a display interface for interacting with the listing data provided by the evaluation server 102. As shown, a remote device 104 is provided with data that is used to generate a listing display 500. Here, the listing display includes one or more images 502 associated with the listing, property details 504, additional properties is the target market 506 (such as those generated in step 204), and the associated realtor details 508.

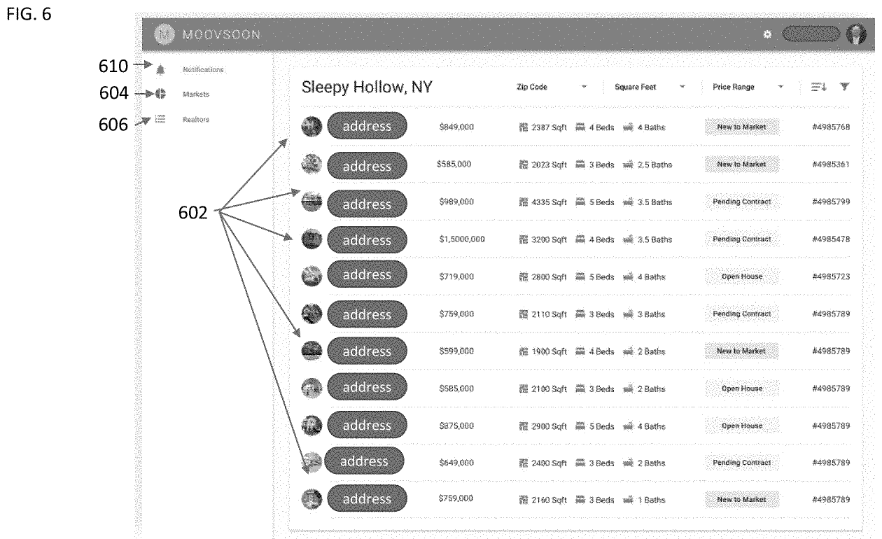

In an alternative view, as shown in FIG. 6, the user interface displayed to the user of a remote device 104 includes a market listing. For example, the user interface is configured to display data from the evaluation server 102 that provides each of the listings 602 included in a target market. Each of the provided listings, in one implementation, includes address information, property details, price, and the status of the listing. The user interface screen provided also includes selection icons (604, 606) that allow the user to access additional functionality. For instance, by selecting on the market icon (604) the user interface receives data from the evaluation server 102 such that each of the categories of markets (i.e. the classified subgroups) are presented to the user for further evaluation. In another configuration, such a market icon permits the user to access one or more tools to generate new market categories or to filter the listing data in a desired manner so as to generate new market groups for evaluation. Also shown is the relator icon 606. The realtor icon initiates functionality to generate a listing of all or some of the realtors referenced in the listing data for a given market, or across the entire accessed data set. The notification icon 610 allows the user to review notifications and or updates based on the evaluation server 102 interactions or data exchanges with the CRM systems and other datasets 108.

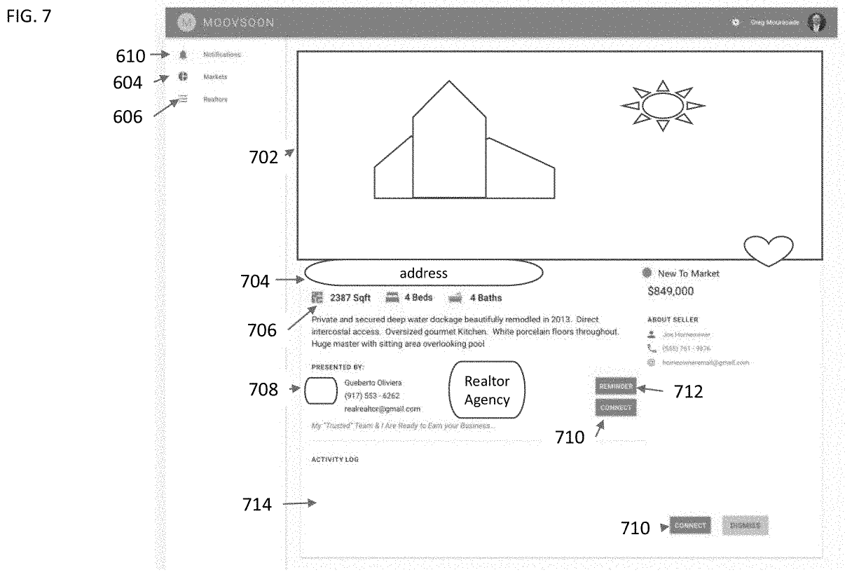

Upon selection of a particular listing, such as one of the entries provided in the display of FIG. 6, the user interface provides a detailed view of the relevant listing as shown in FIG. 7. Here, the user interface provides more details about the particular listing, including images of the property 702, address 704, property details 706, and realtor information 708. Furthermore, the user interface also provides interactive icons for the user to generate a new message to send to the realtor 710 or to update a calendar or scheduling feature 712 to remind the user to follow up. In a further iteration, the user interface includes one or more dynamically updated activity log areas 714, where the communications or exchanges that have been conducted regarding this listing are tracked. For example, if the user interacts with the connect functionality (710), the activity log will be updated with information detailing when and what communication was sent regarding this listing.

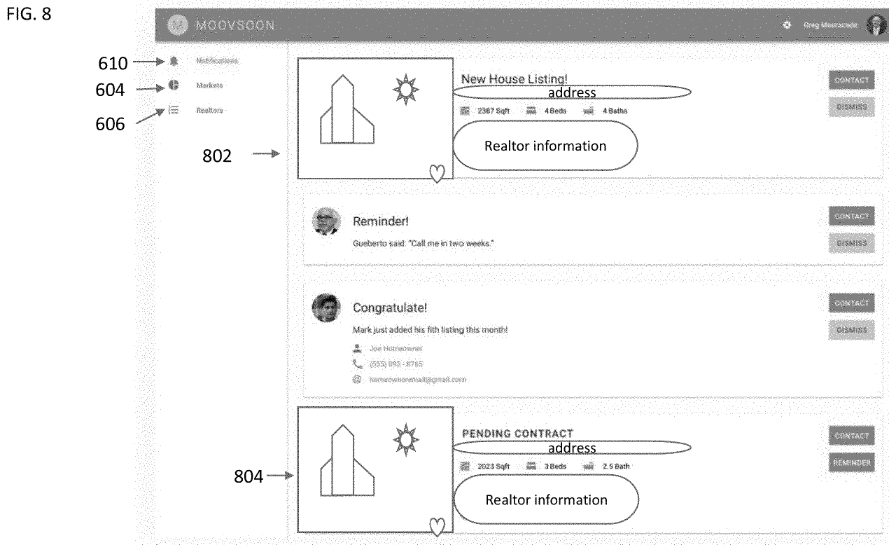

FIG. 8 provides a user interface display for the notifications functionality accessed using element 610. Here, new listings (802) are added to the target markets as they become available. In response to new listing being made available, the evaluation server 102 accesses the listing, and based on the information contained in the listing, assigs the listing to one of the markets. Upon assigning the new listing to one of the markets tracked or evaluated by a specific user, the user is notified of the new listing added to the target market. From the notification screen, the user is able to initiate a message to the realtor by selecting the contact icon. Likewise, where the status of an existing listing has changed, as shown in 804, the user is presented with the opportunity to communicate with the realtor.

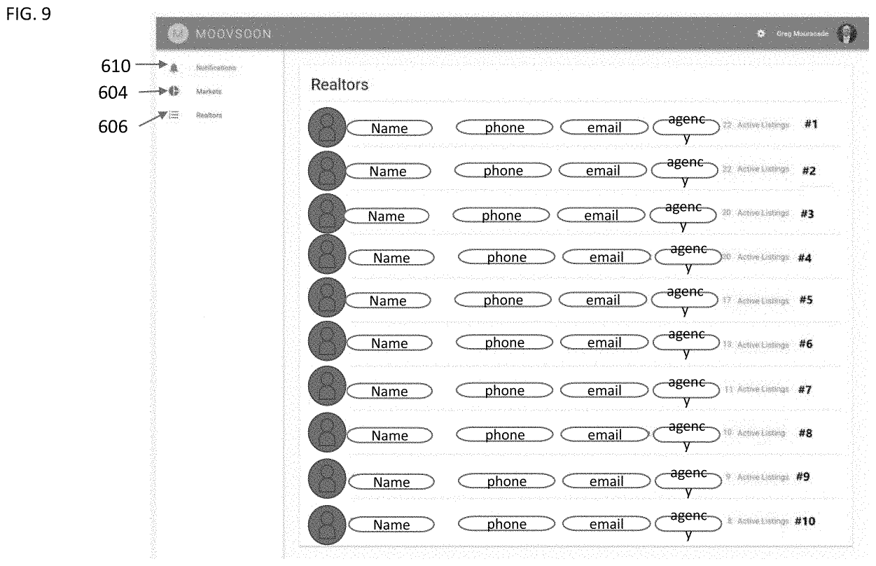

FIG. 9 details the user interface of the realtor tab (606). Here, each realtor within a target market, or in the overall listing, is provided. Each relator is ranked according to the ranking criteria (such as determined in step 311). The user is then able to select one or more realtors for communication based on their relative rank or other criteria (i.e. active listings, region, agency, etc.).

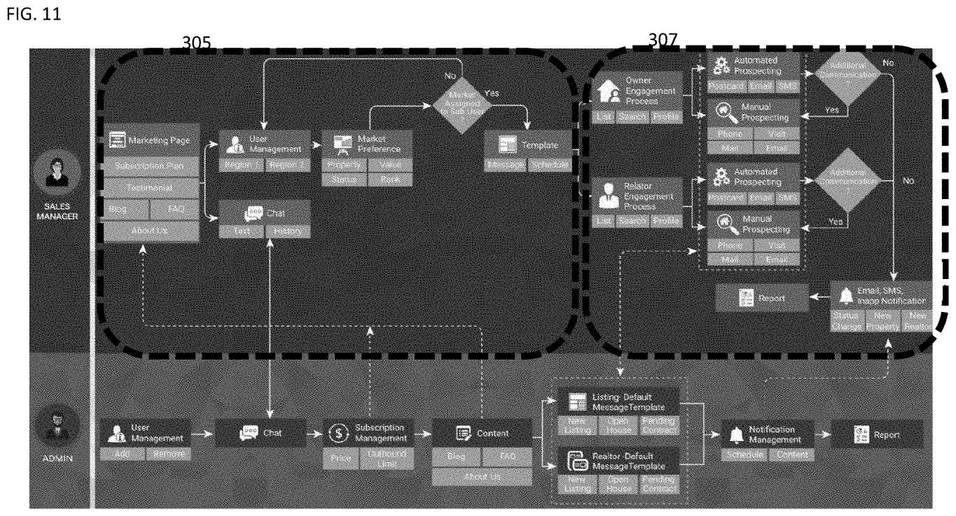

FIG. 11 details the user work flow when carrying out the communications and prospecting functions of the user interface. As shown, the user and administrators of the evaluation system are able to generate and retrieve information about the market in question. For example the user is able to generate market template datasets that will be filled by the unique information responsive to a particular user as shown in 305. Additionally, the user is able to implement an owners or realtor engagement process (307) for initiating and generating follow-up communications. The features provided in FIG. 11, also allow for scheduling and management of the specific content to be sent (either electronic or physical) to vendors or end customers.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems cited throughout this application are incorporated by reference herein. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those claims, and by equivalents of such features.

What is claimed is:

1. A system for tracking real property data comprising:
a processor configured by code executing therein to:
access a dataset from one or more property listing databases;
store the dataset in a data storage device accessible to the processor;
classify, automatically and according to one or more classification criteria, one or more sub-categories of the stored dataset;
rank, using the processor, each entry within the one or more subcategories based on one or more ranking criteria;
generate, automatically using the processor, at least one message for service to each entry in the one or more sub-category that is ranked above a pre-determined threshold;
store, using the processor, in at least one remote database, a copy of the generated message;
send, to at least one recipient, the at least one generated message over an electronic communication network;
receive, from one or more remote users over the electronic communication network, one or more service inquiries; and
associate, within the data storage device, the one or more remote users with the one or more stored generated messages.

2. The system of claim 1, wherein the processor is configured to classify the dataset according to one or more classification criteria by identifying a value associated with each of one or more data fields associated with each entry in the dataset.

3. The system of claim 2, wherein the processor is configured to automatically access, from an alternative database, a dataset corresponding to an entry lacking at least one value for each of the one or more data fields associated with a stored dataset.

4. The system of claim 3, wherein the processor is configured to compare the dataset for an entry that does not have at least one value for one or more data fields with the dataset for the same entry obtained from the alternative database, and update at least one stored dataset entry with the one or more data fields associated with the entry in the dataset obtained from the alternative database, where the entries are substantially similar.

5. The system of claim 4, where the processor is configured to evaluate the substantial similarity of the entry from the database and the entry from the alternative database based on a natural language processing algorithm that evaluates the similarity of each of the values associated with the data fields of each entry.

6. The system of claim 1, wherein for each entry in the dataset, each entry includes at least one of: geospatial data, transaction price, dwelling size, contact information and transaction date.

7. The system of claim 1, wherein the ranking criteria corresponds to the likelihood that a participant in a transaction will purchase additional transaction related services.

8. The system of claim 7, wherein the processor is configured to rank each entry by assigning numerical value to each entry.

9. The system of claim 8, wherein the ranking criteria is generated using a ranking algorithm that receives at least one data value characterizing the entry in the dataset, wherein the data value is included in the dataset and output a value correlated to the likelihood that the transaction with result in the purchase of additional transaction related services.

10. The system of claim 9 wherein the ranking algorithm is a pre-trained neural network or machine learning algorithm.

11. The system of claim 10, wherein the ranking algorithm is configured to rank each entry by assigning numerical value to each entry based on the value of at least one or more data values associated with the entry.

12. The system of claim 1 wherein the processor is further configured to update the rank of each entry based the received service inquiry.

13. A processor is configured by code executing therein to:
access information about the status of a listing in a plurality of network-based non-transitory storage devices having a collection of listing thereon by generating and executing a first query;
providing remote access to users over a network so any one of the users can update the information about the status of a listing in the collection of listings in real time through a graphical user interface, wherein the one of the users provides the updated information in a non-standardized format dependent on the hardware and software platform used by the one of the users;
converting, by an evaluation server, the non-standardized updated information into the standardized format;
d) storing the standardized updated information about the listing status in the collection listings in the standardized format;
e) automatically generating a message containing the updated information about the listing status by the evaluation server whenever updated information has been stored; and
f) transmitting the message to at least a portion of the users over the computer network in real time, so that the at least a portion of the user has immediate access to up-to-date listing information.

14. The processor of claim 13, configured to store the accessed information about the status of a listing.

15. The processor of claim 14, configured to standardize the accessed information about the status of a listing, generating a query to a second of the plurality of network-based non-transitory storage devices, wherein the query is second query is configured to cause the second of the plurality of network-based non-transitory storage to provide the processor substantially the same information accessed by the processor relating to the status of a listing.

16. The processor of claim 15, further configured to compare the results obtained from the second query to the accessed information and generate a combined dataset that includes at least the information about the transaction provided by the first query and the second query.
